(19) United States
(12) Patent Application Publication
(10) Pub. No.: US 2023/0065944 A1
(43) Pub. Date: Mar. 2, 2023

(54) OPTICAL DEFLECTION APPARATUS

(71) Applicant: Tsukasa YAMADA, Tokyo (JP)

(72) Inventor: Tsukasa YAMADA, Tokyo (JP)

(73) Assignee: MITSUMI ELECTRIC CO., LTD., Tokyo (JP)

(21) Appl. No.: 17/821,878

(22) Filed: Aug. 24, 2022

(30) Foreign Application Priority Data
Sep. 1, 2021 (JP) 2021-142789

(51) Int. Cl. H01S 3/101; G02B 26/08

(52) U.S. Cl. CPC H01S 3/101; G02B 26/0833

(57) ABSTRACT

An optical deflection apparatus includes a movable member configured to deflect incident light from a light emitter, and a lid member configured to cover the movable member. The lid member includes an opening through which the incident light and deflected light of the incident light pass. The deflected light is deflected by the movable member. The lid member includes a light attenuation portion configured to attenuate reflected light of the incident light or of the deflected light. The reflected light is reflected by the lid member.

### CROSS-REFERENCE TO RELATED APPLICATIONS

This application is based on and claims priority to Japanese Patent Application No. 2021-142789, filed on Sep. 1, 2021, the entire contents of which are incorporated herein by reference.

### BACKGROUND OF THE INVENTION

### 1. Field of the Invention

The disclosure herein relates to an optical deflection apparatus.

### 2. Description of the Related Art

Optical deflection apparatuses that include a movable member configured to deflect incident light from a light emitter are known.

Further, an optical deflection apparatus that includes a lid member configured to cover a movable member is disclosed, in which the surface of a recess formed in the lid member has a root mean square roughness of less than or equal to 15 nm (see Patent Document 1, for example).

The lid member configured to cover the movable member has an opening through which incident light from a light emitter and deflected light of the incident light, deflected by the movable member, pass. In order to reduce disturbance light entering from the outside into the optical deflection apparatus, the width of the opening is preferably as small as possible. However, if the opening has a small width, incident light from the light emitter or deflected light of the incident light may be reflected by the front surface or the back surface of the lid member in the vicinity of the opening or may be reflected by the inner surface of the opening, and as a result, unintentional stray light may be generated.

### RELATED-ART DOCUMENTS

### Patent Documents

Patent Document 1: Japanese Patent No. 5704927

### SUMMARY OF THE INVENTION

It is desirable to provide an optical deflection apparatus capable of reducing stray light.

According to an embodiment of the present disclosure, an optical deflection apparatus includes a movable member configured to deflect incident light from a light emitter, and a lid member configured to cover the movable member. The lid member includes an opening through which the incident light and deflected light of the incident light pass. The deflected light is deflected by the movable member. The lid member includes a light attenuation portion configured to attenuate reflected light of the incident light or of the deflected light. The reflected light is reflected by the lid member.

### BRIEF DESCRIPTION OF THE DRAWINGS

Other objects and further features of the present invention will be apparent from the following detailed description when read in conjunction with the accompanying drawings, in which:

FIG. 1 is a perspective view illustrating the overall configuration of an optical deflection apparatus according to an embodiment;

FIG. 2 is a perspective view of the optical deflection apparatus from which a light transmission plate is removed;

FIG. 3 is a perspective view illustrating a configuration of an optical deflector according to the embodiment;

FIG. 4 is a plan view illustrating the configuration of the optical deflector according to the embodiment;

FIG. 5A is a graph illustrating examples of horizontal drive signals of the optical deflector;

FIG. 5B is a graph illustrating examples of vertical drive signals of the optical deflector;

FIG. 6 is a perspective view illustrating a laser beam that passes through an opening;

FIG. 7A is a graph illustrating a cross-sectional intensity distribution of the laser beam in the X direction;

FIG. 7B is a graph illustrating a cross-sectional intensity distribution of the laser beam in the Y direction;

FIG. 8 is a diagram illustrating effective beam widths of the laser beam;

FIG. 9 is a diagram illustrating the relationship between the effective beam widths and a stop;

FIG. 10 is a diagram illustrating a light attenuation portion provided on each of a front surface of a lid and an inner surface of the opening of the lid in the optical deflection apparatus;

FIG. 11 is a diagram illustrating the light attenuation portion provided on the back surface of the lid in the optical deflection apparatus;

FIG. 12 is a diagram illustrating a light scattering surface that is a first example of the light attenuation portion according to the embodiment;

FIG. 13 is a diagram illustrating a colored surface that is a second example of the light attenuation portion according to the embodiment;

FIG. 14 is a perspective view illustrating a configuration of the inner surface of the opening according to the embodiment;

FIG. 15 is a cross-sectional view illustrating an example of inclination of a first inner surface of the opening according to the embodiment;

FIG. 16 is a cross-sectional view illustrating an example of inclination of a second inner surface of the opening according to the embodiment;

FIG. 17 is a perspective view illustrating a configuration of an optical deflection apparatus according to a first modification;

FIG. 18 is a perspective view of the optical deflection apparatus of FIG. 17 from which a light transmission plate is removed;

FIG. 19 is a diagram illustrating a light attenuation portion provided on each of a front surface of a lid and an inner surface of an opening of the lid in the optical deflection apparatus of FIG. 17;

FIG. 20 is a diagram illustrating the light attenuation portion provided on a back surface of the lid in the optical deflection apparatus of FIG. 17,

FIG. 21 is a perspective view illustrating a configuration of an optical deflection apparatus according to a second modification;

FIG. 22 is a diagram illustrating a light attenuation portion provided on each of a front surface of a lid and an inner surface of an opening of the lid in the optical deflection apparatus of FIG. 21; and

FIG. 23 is a diagram illustrating the light attenuation portion provided on a back surface of the lid in the optical deflection apparatus of FIG. 21.

### DESCRIPTION OF THE EMBODIMENTS

In the following, embodiments of the present invention will be described with reference to the drawings. In the drawings, the same elements are denoted by the same reference numerals and the description thereof may be omitted.

The embodiments described below exemplify an optical deflection apparatus for embodying the technical idea of the present invention, and the present invention is not limited to the following embodiments. Unless otherwise specified, the dimensions, materials, shapes, relative arrangements, and the like of constituent elements described below are not intended to limit the scope of the present invention, and are merely examples. Further, the sizes, positional relationships, and the like of elements illustrated in the drawings may be exaggerated to clarify the description.

In the drawings, the X-axis, Y-axis, and Z-axis may indicate directions. The X direction along the X-axis and the Y direction along the Y-axis are two directions that are substantially perpendicular to a direction in which a movable member of an optical deflection apparatus according to an embodiment deflects light. The Z direction along the Z-axis is a direction that is substantially perpendicular to both the X-axis and the Y-axis.

Further, a direction indicated by an arrow in the X direction is defined as a +X direction, a direction opposite to the +X direction is defined as a −X direction, a direction indicated by an arrow in the Y direction is defined as a +Y direction, a direction opposite to the +Y direction is defined as a −Y direction, a direction indicated by an arrow in the Z direction is defined as a +Z direction, and a direction opposite to the +Z direction is defined as a −Z direction. However, the above-described directions do not limit the direction in which the optical deflection apparatus is used, and the optical deflection apparatus may be disposed in any direction.

### Embodiments

### Example of Overall Configuration of Optical Deflection Apparatus 50

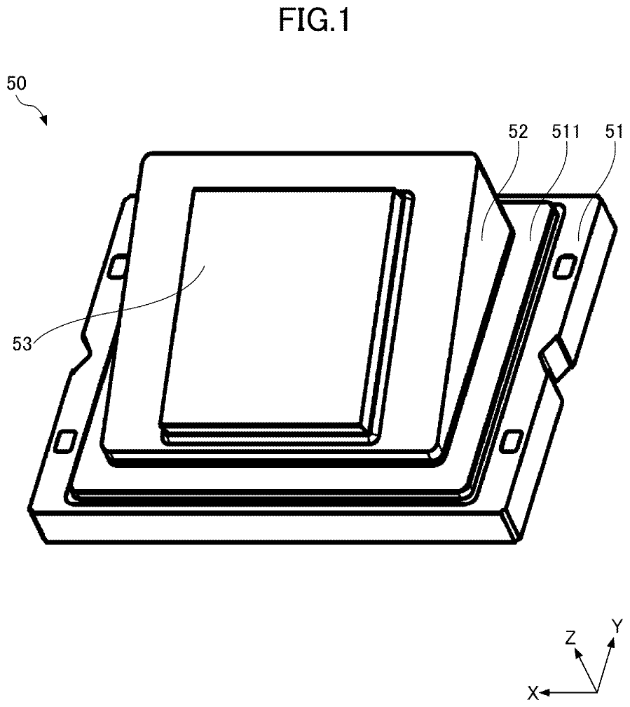

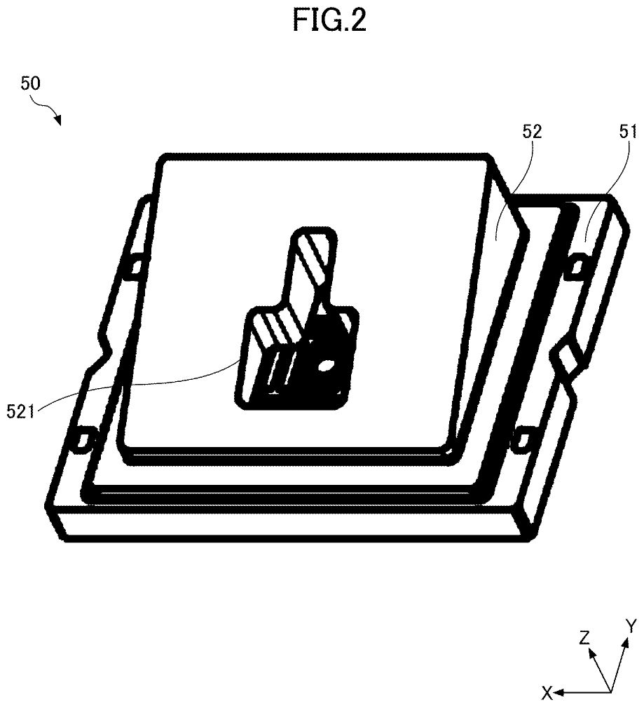

Referring to FIG. 1 and FIG. 2, the overall configuration of an optical deflection apparatus 50 according to an embodiment will be described. FIG. 1 is a perspective view illustrating the overall configuration of the optical deflection apparatus 50. FIG. 2 is a perspective view of the optical deflection apparatus 50 from which a light transmission plate 53 is removed.

As illustrated in FIG. 1 and FIG. 2, the optical deflection apparatus 50 includes a package 51 and a lid 52. The lid 52 is provided on +Z side of the package 51. The lid 52 has an opening 521 that is a through-hole. Further, the light transmission plate 53 is provided on +Z side of the lid 52.

In the optical deflection apparatus 50, a laser beam, emitted from a light emitter, transmitted through the light transmission plate 53, and passing through the opening 521 of the lid 52, is deflected by an optical deflector provided in the package 51. The light emitter is provided on the outside of the optical deflection apparatus 50. The light emitter may be, for example, a semiconductor laser. The light emitter may include a plurality of semiconductor lasers that emit laser beams of different wavelengths.

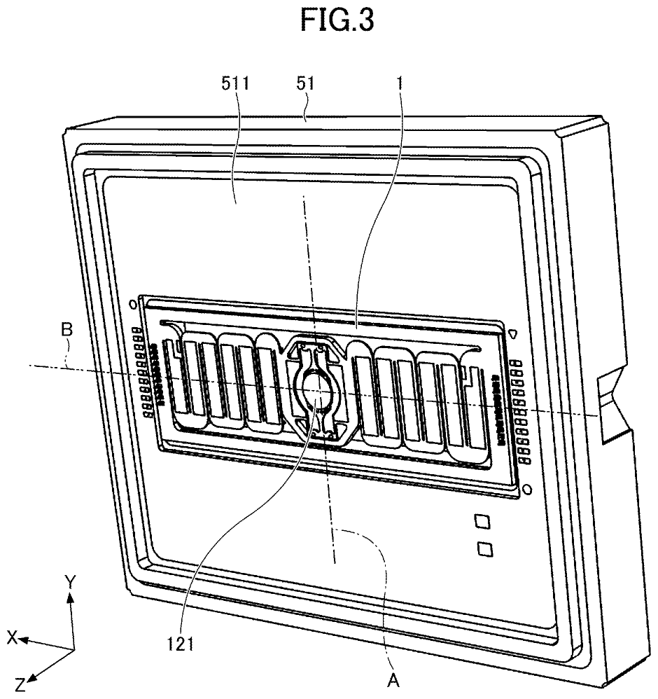

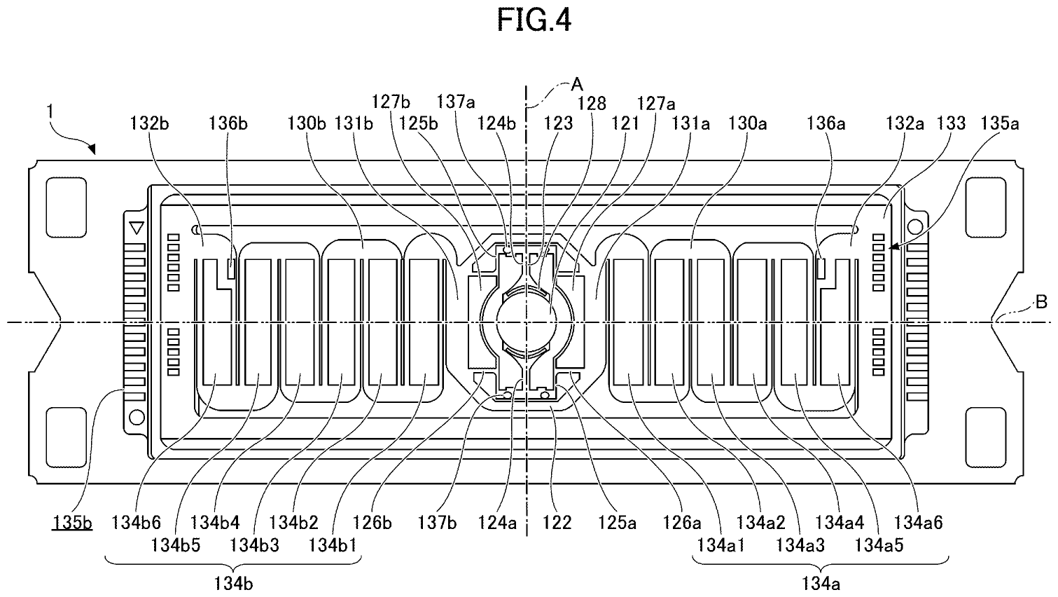

As used herein, deflecting light refers to changing the traveling direction of light such as a laser beam. The optical deflector according to the embodiment deflects light by reflecting the light on the reflection surface. A configuration of the optical deflector will be separately described in detail with reference to FIG. 3 and FIG. 4.

The package 51 is a box-shaped member that holds the optical deflector within the package 51. The package 51 is formed of an alumina ceramic material, a metal material such as aluminum, an aluminum alloy, or stainless steel, a plastic material, or the like. The package 51 includes circuit boards and the like configured by fiber reinforced plastics (FRPs), flexible printed circuits (FPCs), or the like.

The lid 52 is an example of a lid member configured to cover a movable member of the optical deflector. The lid 52 holds the light transmission plate 53 and also serves to reduce disturbance light entering from the outside into the optical deflection apparatus 50.

The lid 52 is formed of a material that does not have a light-transmitting property with respect to a laser beam emitted from the light emitter, such as alumina ceramic, aluminum, an aluminum alloy, stainless steel, or plastic. The lid 52 is a box-shaped member having a substantially square shape in a plan view as viewed in the Z direction. The lid 52 is fixed to a placement surface 511 on the +Z side of the package 51 with an adhesive member or the like, in a state in which the −Z side of the lid 52 contacts the placement surface 511.

The surface on the +Z side of the lid 52 is inclined with respect to the placement surface 511. The light transmission plate 53 is fixed to and held by the inclined surface of the lid 52 with an adhesive member, a low-melting-point glass welding member, or the like.

The light transmission plate 53 is a plate-shaped member that transmits a laser beam emitted from the light emitter and also transmits a laser beam deflected by the optical deflector. The light transmission plate 53 is formed of a material that has a light-transmitting property with respect to a laser beam emitted from the light emitter, such as optical glass, heat-resistant glass, hard glass, optical plastic, or hard plastic. An antireflection film for preventing reflection of laser beams may be provided on each of the surface on the +Z side and the surface on the −Z side of the light transmission plate 53.

The surface on the +Z side of the lid 52, which contacts the light transmission plate 53, is inclined with respect to the placement surface 511. Therefore, the light transmission plate 53 is held by the lid 52 in a state in which the light transmission plate 53 is inclined with respect to the placement surface 511. The lid 52 and the light transmission plate 53 provide sealing, thus preventing dust, dirt, or the like from adhering to the optical deflector disposed inside the lid 52, and also preventing moisture or oxygen from entering the inside of the lid 52 of the optical deflection apparatus 50.

### Example Configuration of Optical Deflector 1

Referring to FIG. 3 and FIG. 4, a configuration of an optical deflector 1 will be described. FIG. 3 and FIG. 4 are diagrams illustrating an example configuration of the optical deflector 1. FIG. 3 is a perspective view illustrating a configuration of the optical deflector 1, and FIG. 4 is a plan view illustrating the configuration of the optical deflector 1 as viewed in the +Z direction. FIG. 3 illustrates the optical deflection apparatus 50 from which the lid 52 and the light transmission plate 53 are removed, and FIG. 4 illustrates the optical deflection apparatus 50 of FIG. 3 from which the package 51 is further removed.

As illustrated in FIG. 3, the optical deflector 1 includes a movable member 121 configured to deflect a laser beam from the light emitter. The optical deflector 1 is held by the package 51 such that the movable member 121 is disposed around the center of the package 51.

A reflection surface is formed on the surface on the +Z side of the movable member 121. The movable member 121 is configured to oscillate about a first oscillation axis A and about a second oscillation axis B. The optical deflector 1 can deflect a laser beam, incident on the movable member 121, in the X direction and in the Y direction by causing the movable member 121 to oscillate. The optical deflector 1 is, for example, a microelectromechanical systems (MEMS) mirror that uses piezoelectric elements as drive sources to cause the movable member 121 to oscillate. Note that the piezoelectric drive type MEMS mirror is taken as an example, but the present invention is not limited thereto, and an electromagnetic drive type MEMS mirror or an electrostatic drive type MEMS mirror may be used.

As illustrated in FIG. 4, the optical deflector 1 includes the movable member 121, a movable frame 122, a support portion 123, torsion beams 124a and 124b, connection beams 125a and 125b, first driving beams 126a and 126b, second driving beams 130a and 130b, and a fixed frame 133. Further, the optical deflector 1 includes a movable frame connection portion 131a, a fixed frame connection portion 132a, a movable frame connection portion 131b, and a fixed frame connection portion 132b.

The movable frame 122 supports the movable member 121 from the outside. The pair of second driving beams 130a and 130b supports the movable frame 122 from both sides.

The movable frame connection portion 131a is a portion that connects the movable frame 122 and the second driving beam 130a. The fixed frame connection portion 132a is a portion that connects the fixed frame 133 and the second driving beam 130a. The movable frame connection portion 131b is a portion that connects the movable frame 122 and the second driving beam 130b. The fixed frame connection portion 132b is a portion that connects the fixed frame 133 and the second driving beam 130b.

The first driving beam 126a includes a drive source 127a, and the first driving beam 126b includes a drive source 127b. The second driving beam 130a includes a drive source 134a, and the second driving beam 130b includes a drive source 134b.

The first driving beams 126a and 126b function as actuators that cause the movable member 121 to oscillate about the first oscillation axis A so as to deflect laser light. The second driving beams 130a and 130b function as actuators that cause the movable member 121 to oscillate about the second oscillation axis B so as to deflect laser light.

Slits 128 are formed in the support portion 123 along the circumference of the movable member 121. The slits 128 can prevent damage to the reflection surface by dispersing stress concentration generated by the torsional motion of the torsion beams 24a and 24b, while transmitting the torsion of the torsion beams 124a and 124b to the movable member 121.

In the optical deflector 1, the movable member 121 is supported on the upper surface of the support portion 123. The support portion 123 is connected to the ends of the torsion beams 124a and 124b provided on both sides of the support portion 123. The torsion beams 124a and 124b form the first oscillation axis A, extend in a direction parallel to the first oscillation axis A, and support the support portion 123 from both sides in the direction parallel to the first oscillation axis A.

The torsion of the torsion beams 124a and 124b causes the movable member 121 supported by the support portion 123 to oscillate so as to deflect reflected light of laser light incident on the movable member 121. The torsion beams 124a and 124b are connected to and supported by the connection beams 125a and 125b, respectively, and the connection beams 125a and 125b are connected to the first driving beams 126a and 126b, respectively.

The first driving beams 126a and 126b, the connection beams 125a and 125b, the torsion beams 124a and 124b, the support portion 123, and the movable member 121 are supported from the outside by the movable frame 122.

One side of each of the first driving beams 126a and 126b is supported by the movable frame 122. The other side of the first driving beam 126a extends inward and is connected to the connection beams 125a and 125b. Similarly, the other side of the first driving beam 126b extends inward and is connected to the connection beams 125a and 125b.

The first driving beams 126a and 126b are paired so as to interpose the movable member 121 and the support portion 123, in a direction perpendicular to the torsion beams 124a and 124b. The drive source 127a is formed on the upper surface of the first driving beam 126a, and the drive source 127b is formed on the upper surface of the first driving beam 126b.

The drive sources 127a and 127b include upper electrodes formed on thin films of piezoelectric elements (hereinafter also referred to as “piezoelectric thin films”) on the upper surfaces of the first driving beams 126a and 126b, and lower electrodes formed on the lower surfaces of the piezoelectric thin films. Each of the drive sources 127a and 127b expands and contracts according to a polarity of a drive voltage applied to corresponding upper and lower electrodes.

When drive voltages of different phases are alternately applied between the first driving beam 126a and the first driving beam 126b, the first driving beam 126a and the first driving beam 126b alternately vibrate vertically in opposite directions, on right and left sides of the movable member 121.

Accordingly, the optical deflector 1 can cause the movable member 121 to oscillate about the first oscillation axis A formed by the torsion beams 124a and 124b. For example, resonant vibration can be used for oscillation about the first oscillation axis A by the first driving beams 126a and 126b. In this case, the movable member 121 can oscillate at a high speed.

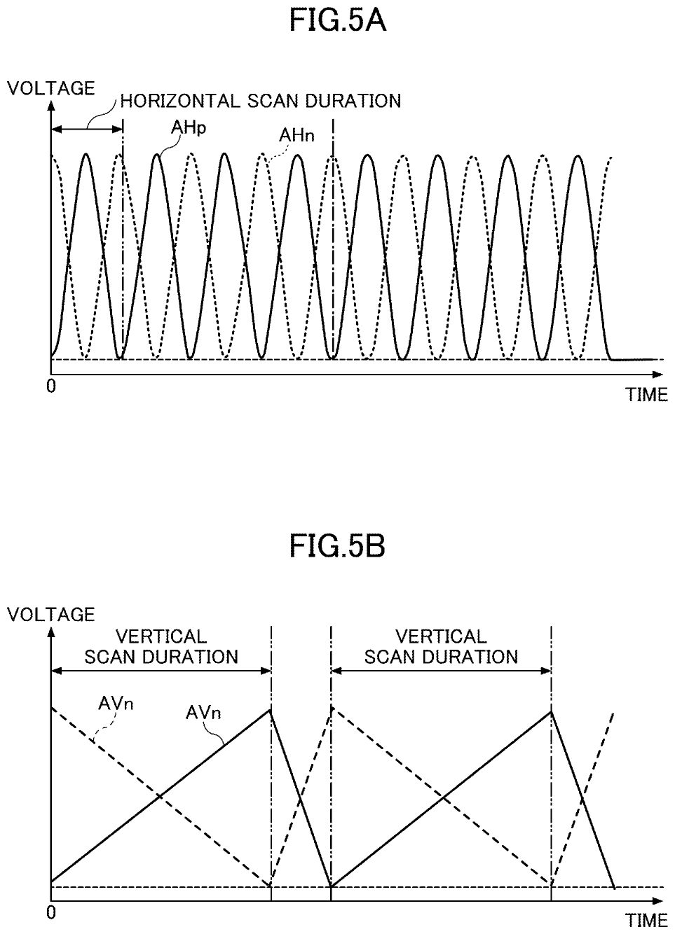

FIG. 5A and FIG. 5B are graphs illustrating drive signals. FIG. 5A is a graph illustrating examples of horizontal drive signals. FIG. 5B is a graph illustrating examples of vertical drive signals.

As illustrated in FIGS. 5A and 5B, both a horizontal drive signal AHp and a horizontal drive signal AHn are sinusoidal waves with the same cycle and amplitude. The phase of the horizontal driving signal AHn is shifted by a half-cycle with respect to the phase of the horizontal drive signal AHp. Specifically, the horizontal drive signals AHp and AHn are in such a relationship that the potentials of the horizontal drive signals AHp and AHn are inverted with respect to an intermediate potential. The movable member 121 is driven according to a potential difference between the horizontal drive signal AHp and the horizontal drive signal AHn. The oscillation angle of the movable member 121 corresponds to the amplitudes of the horizontal driving signal AHp and the horizontal driving signal AHn.

Referring back to FIG. 4, one end of each of the second driving beams 130a and 130b is connected to an outer portion of the movable frame 122 via the movable frame connection portions 131a and 131b. The second driving beams 130a and 130b are paired so as to interpose the movable frame 122 from both sides. The second driving beams 130a and 130b support the movable frame 122 from both sides, and also cause the movable frame 122 to oscillate about the second oscillation axis B.

The other end of the second driving beam 130a is connected to an inner portion of the fixed frame 133 via the fixed frame connection portion 132a. The other end of the second driving beam 130b is connected to an inner portion of the fixed frame 133 via the fixed frame connection portion 132b.

As illustrated in FIG. 4, the second driving beam 130a includes a plurality of rectangular vertical beams that extend along the first oscillation axis A and turning portions that connect the ends of adjacent vertical beams to form a zigzag shape as a whole.

For example, when counted from the side closer to the first driving beam 126a, the end of the first vertical beam and the end of the second vertical beam are connected by a turning portion. The end of the second vertical beam and the end of the third vertical beam are connected by a turning portion. The end of the third vertical beam and the end of the fourth vertical beam are connected by a turning portion. The end of the fourth vertical beam and the end of the fifth vertical beam are connected by a turning portion. The end of the fifth vertical beam and the end of the sixth vertical beam are connected by a turning portion.

Similarly, the second driving beam 130b includes a plurality of rectangular vertical beams that extend along the first oscillation axis A and turning portions that connect the ends of adjacent vertical beams to form a zigzag shape as a whole.

For example, when counted from the side closer to the first driving beam 126b, the end of the first vertical beam and the end of the second vertical beam are connected by a turning portion. The end of the second vertical beam and the end of the third vertical beam are connected by a turning portion. The end of the third vertical beam and the end of the fourth vertical beam are connected by a turning portion. The end of the fourth vertical beam and the end of the fifth vertical beam are connected by a turning portion. The end of the fifth vertical beam and the end of the sixth vertical beam are connected by a turning portion.

The drive source 134a is formed on the upper surface of each of the vertical beams of the second driving beam 130a, and the drive source 134b is formed on the upper surface of each of the vertical beams of the second driving beam 130b. The vertical beams are rectangular units including no curved portions.

The drive source 134a includes an upper electrode formed on a piezoelectric thin film on the upper surface of the second driving beam 130a, and a lower electrode formed on the lower surface of the piezoelectric thin film. The drive source 134b includes an upper electrode formed on a piezoelectric thin film on the upper surface of the second driving beam 130b, and a lower electrode formed on the lower surface of the piezoelectric thin film.

When drive voltages are applied to the drive sources 134a and 134b, the vertical beams adjacent to each other of the second driving beams 130a and 130b deflect in the upward direction, and accumulated upward and downward movements of each of the vertical beams are transferred to the movable frame 122.

By the above described operation, the second driving beams 130a and 130b cause the movable member 121 to oscillate about the second oscillation axis B. For example, non-resonant vibration can be used for oscillation by the second driving beams 130a and 130b.

For example, the drive source 134a includes drive sources 134a1, 134a2, 134a3, 134a4, 134a5, and 134a6 that are arranged toward the right side from the movable frame 122. The drive source 134b includes drive sources 134b1, 134b2, 134b3, 134b4, 134b5, and 134b6 that are arranged toward the left side from the movable frame 122. In this case, waveforms of the same shape are applied to the drive sources 134a1, 134b1, 134a3, 134b3, 134a5, and 134b5, and waveforms obtained by inverting the above waveforms in time series are applied to the drive sources 134a2, 134b2, 134a4, 134b4, 134a6, and 134b6. As a result, the movable member 121 can oscillate about the second oscillation axis B.

Driving interconnections for applying the drive voltage to the upper electrode and the lower electrode of the drive source 127a are connected to predetermined terminals included in a terminal group 135a that is provided on the fixed frame 133. Driving interconnections for applying the drive voltage to the upper electrode and the lower electrode of the drive source 127b are connected to predetermined terminals included in a terminal group 135b that is provided on the fixed frame 133.

Driving interconnections for applying the drive voltage to the upper electrode and the lower electrode of the drive source 134a are connected to predetermined terminals included in the terminal group 135a that is provided on the fixed frame 133. Driving interconnections for applying the drive voltage to the upper electrode and the lower electrode of the drive source 134b are connected to predetermined terminals included in the terminal group 135b that is provided on the fixed frame 133.

Further, the optical deflector 1 includes horizontal piezoelectric sensors 137a and 137b. The horizontal piezoelectric sensors 137a and 137b are horizontal oscillation angle sensors that detect the degree of inclination in the horizontal direction (that is, an oscillation angle in the horizontal direction) in a state in which the movable member 121 oscillates in the horizontal direction, and also are vibration sensors that detect the emission timing of laser light. The horizontal piezoelectric sensors 137a and 137b are provided on the connection beams 125a and 125b.

Further, the optical deflector 1 includes vertical piezoelectric sensors 136a and 136b. The vertical piezoelectric sensors 136a and 136b are vertical oscillation angle sensors that detect the degree of inclination in the vertical direction (that is, an oscillation angle in the vertical direction) in a state in which the movable member 121 oscillates in the vertical direction, and also are vibration sensors that detect unnecessary vibration of the vertical beams in order to remove unnecessary vibration components from the drive signals. Each of the vertical piezoelectric sensors 136a and 136b is provided on one of the vertical beams of the second driving beams 130a and 130b.

The optical deflector 1 may be produced by, for example, a semiconductor process using a silicon on insulator (SOI) substrate including a support layer, a buried oxide (BOX) layer, and an active layer.

### Example Reflection of Laser Beam L by Lid 52

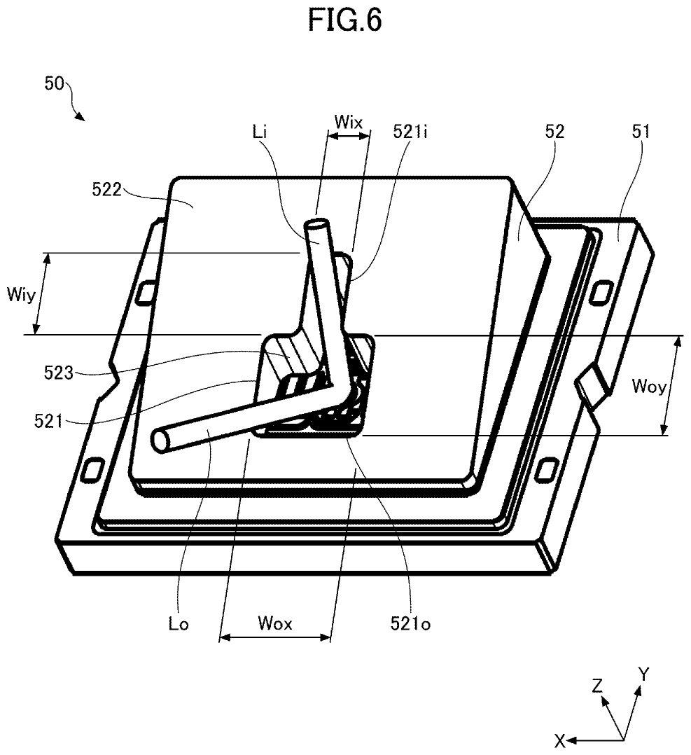

Referring to FIG. 6 through FIG. 9, reflection of a laser beam L by the lid 52 will be described. FIG. 6 is a perspective view illustrating the laser beam L that passes through the opening 521 of the lid 52.

The laser beam L collectively refers to an incident laser beam Li and a deflected laser beam Lo when the incident laser beam Li and the deflected laser beam Lo are not specifically distinguished. The incident laser beam Li is an example of incident light from the light emitter. The deflected laser beam Lo is an example of deflected light of the incident light. The deflected light is deflected by the movable member 121.

As illustrated in FIG. 6, the opening 521 includes an incident-side opening 521i through which the incident laser beam Li passes, and an exit-side opening 521o through which the deflected laser beam Lo (an example of deflected light) passes. The opening 521 has an inner surface 523. The inner surface 523 is the inner side surface of the through-hole having a thickness in the Z direction and constituting the opening 521.

The lid 52 has a front surface 522 on the +Z side thereof. The front surface 522 corresponds to a surface on the opposite side of the lid 52 from the movable member 121. A surface (a back surface) on the −Z side of the lid 52 corresponds to a surface on the movable member 121 side of the lid 52.

The width of the opening 521 is preferably as small as possible in order to reduce disturbance light entering from the outside into the optical deflection apparatus 50. The incident direction of the incident laser beam Li does not change. Thus, the width of the incident-side opening 521i is preferably slightly greater than the effective beam diameter of the laser beam L so as not to interfere with the effective beam diameter of the laser beam L. Conversely, the exit direction of the deflected laser beam Lo varies depending on the deflection by the movable member 121. Thus, the width of the exit-side opening 521o is preferably formed so as not to interfere with the deflected laser beam Lo, based on the effective beam width of the laser beam L and the oscillation angle of the movable member 121.

In the present embodiment, an incident-side opening width Wiy in the Y direction of the incident-side opening 521i is formed so as to be greater than an incident-side opening width Wix in the X direction, such that the incident-side opening 521i and the exit-side opening 521o can be continuously formed in the Y direction. The incident-side opening width Wix is formed so as to be slightly greater than the effective beam width of the laser beam L. An exit-side opening width Wox in the X direction of the exit-side opening 521o is formed so as to be greater than the incident-side opening width Wix in accordance with the oscillation angle of the movable member 121. An exit-side opening width Woy in the Y direction of the exit-side opening 521o is formed so as to be approximately the same as the incident-side opening width Wiy.

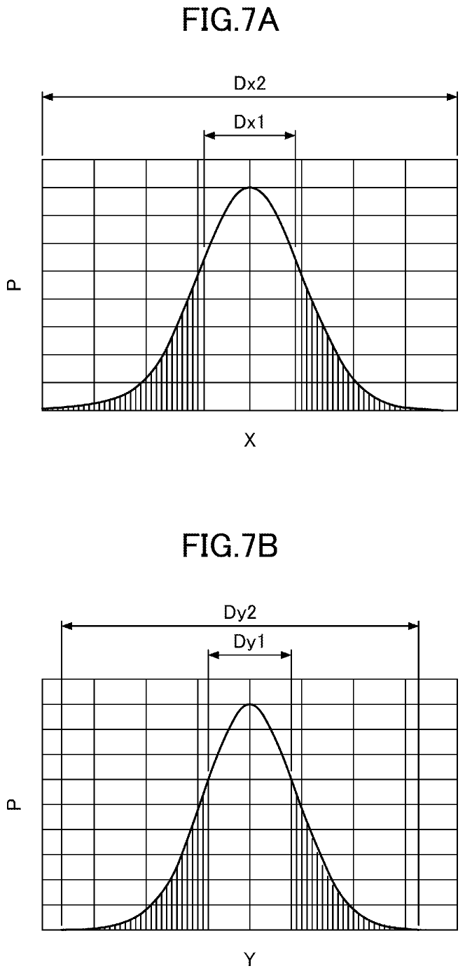

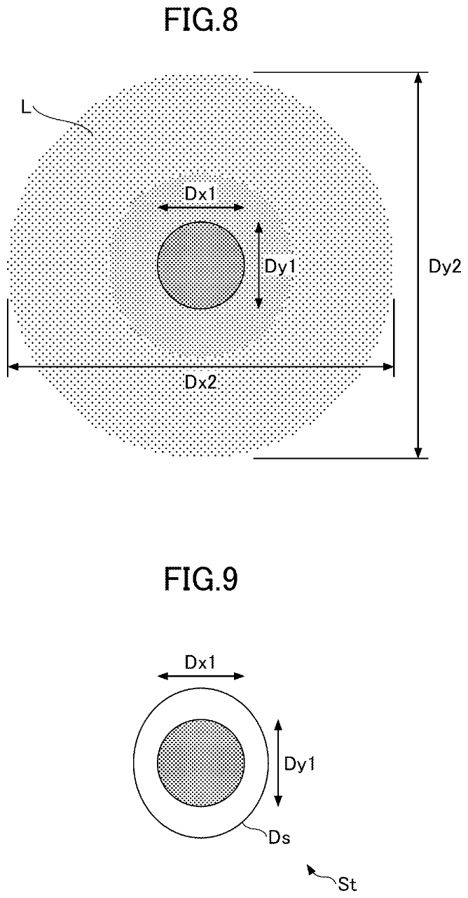

FIG. 7A is a graph illustrating a cross-sectional intensity distribution of the laser beam L in the X direction. FIG. 7B is a graph illustrating a cross-sectional intensity distribution of the laser beam L in the Y direction. FIG. 8 is a diagram illustrating effective beam widths of the laser beam L.

The cross-sectional intensity distributions of the laser beam L refer to intensity distributions in the cross sections of the laser beam L taken along a plane perpendicular to the central axis of the laser beam L and taken along a line passing through the central axis of the laser beam L. The vertical axis in each of FIG. 7A and FIG. 7B represents the light intensity P of the laser beam L. The horizontal axis in FIG. 7A represents the position in the X direction, and the horizontal axis in FIG. 7B represents the position in the Y direction.

Each of the cross-sectional intensity distributions of the laser beam L approximately follows a normal distribution. As illustrated in FIG. 7A, FIG. 7B, and FIG. 8, in the cross-sectional intensity distributions of the laser beam L, a maximum beam width Dx2 is the maximum width of the laser beam L in the X direction. A maximum beam width Dy2 is the maximum width of the laser beam L in the Y direction. An effective beam width Dx1 is the full width at half maximum of the laser beam L in the X direction. An effective beam width Dy1 is the full width at half maximum of the laser beam L in the Y direction.

When the incident-side opening width Wix is formed so as to be greater than the effective beam width Dx1 and smaller than the maximum beam width Dx2, a part of the incident laser beam Li, which falls outside the effective beam width Dx1, is incident on the front surface 522 of the lid 52 and is reflected by the front surface 522 in the +Z direction. This reflected light may sometimes become unintentional stray light. In addition, depending on the size of the incident-side opening width Wiy, a part of the incident laser beam Li in the Y direction may be incident on the front surface 522 and reflected by the front surface 522. This reflected light may sometimes become unintentional stray light.

Further, when the exit-side opening widths Wox and Woy are formed such that only the deflected laser beam Lo within the effective beam widths Dx1 and Dy1 can pass through the opening, a part of the deflected laser beam Lo, which falls outside the effective beam widths Dx1 and Dy1, is incident on the back surface of the lid 52 and is reflected by the back surface of the lid 52 in the −Z direction. The light reflected by the back surface of the lid 52 may be repeatedly reflected by the movable member 121, the back surface of the lid 52, and the like, and subsequently, the reflected light may exit in the +Z direction and may sometimes become stray light.

Further, a part of the incident laser beam Li and a part of the deflected laser beam Lo may be incident on the inner surface 523 of the opening 521 and reflected by the inner surface 523, and the reflected light may sometimes become stray light.

In order to reduce stray light, it can be considered that a stop St serving as a spatial filter may be provided between the light emitter and the optical deflection apparatus 50. However, as illustrated in FIG. 9, if a stop diameter Ds is set to be greater than the effective beam widths Dx1 and Dy1, a part of the laser beam L, which falls outside the effective beam widths Dx1 and Dy1, passes through the stop St. Stray light may be generated by the light that has passed through the stop St.

### Example Configuration of Lid 52

In the present embodiment, the lid 52 of the optical deflection apparatus 50 includes a light attenuation portion 100 configured to attenuate reflected light of the incident laser beam Li or of the deflected laser beam Lo. The reflected light is reflected by the lid 52. The light attenuation portion 100 is provided on each of the front surface 522, a back surface 524, and the inner surface 523 of the lid 52.

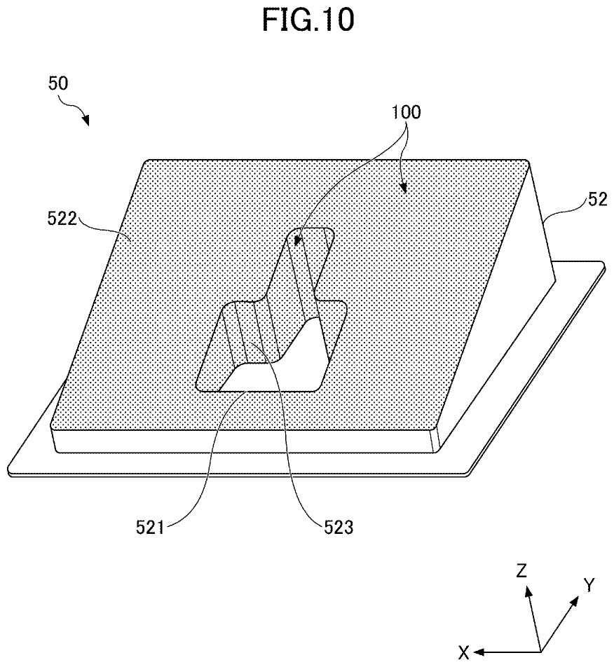

FIG. 10 is a diagram illustrating the light attenuation portion 100 provided on each of the front surface 522 of the lid 52 and the inner surface of the opening 521 of the lid 52 in the optical deflection apparatus 50. FIG. 11 is a diagram illustrating the light attenuation portion 100 provided on the back surface of the lid 52 in the optical deflection apparatus 50.

The light attenuation portion 100 is, for example, a light scattering surface that scatters light reflected by the lid 52 so as to attenuate the light. In FIG. 10, the light attenuation portion 100 is provided on each of the front surface 522 and the inner surface 523 indicated by dot hatching. In FIG. 11, the light attenuation portion 100 is provided on the back surface 524 indicated by dot hatching.

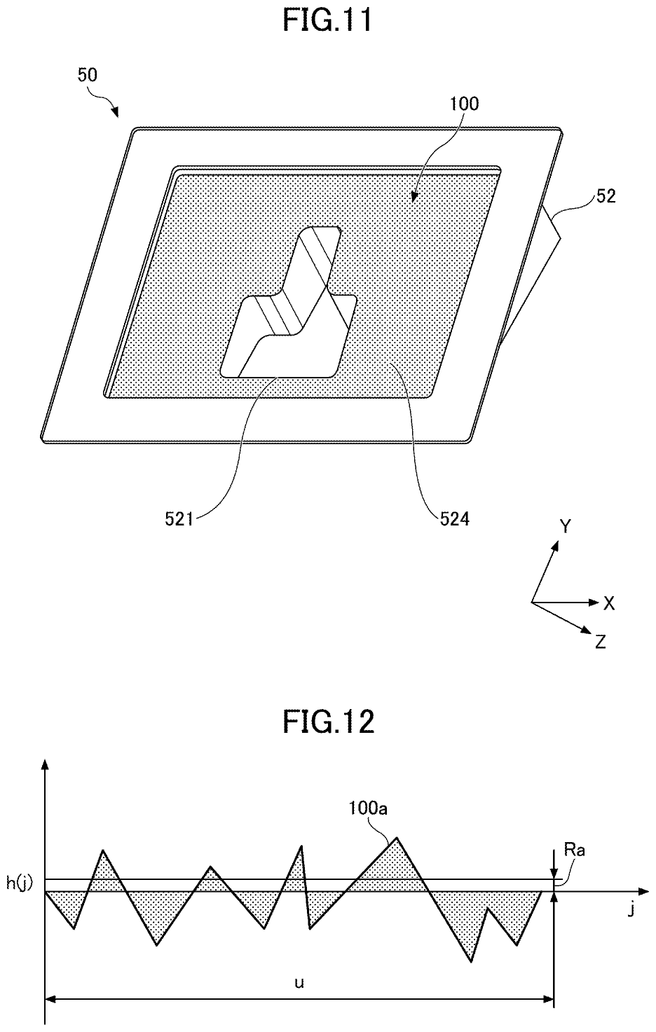

FIG. 12 is a diagram illustrating a light scattering surface 100a that is a first example of the light attenuation portion 100. FIG. 12 illustrates a cross-section of a part of the light scattering surface 100a. The horizontal axis represents a position j, and the vertical axis represents a height h(j) for each position j.

The inventers made earnest investigations by producing a plurality of lids 52 whose front surfaces 522, back surfaces 524, and inner surfaces 523 have different roughness, and evaluating stray light of an optical deflection apparatus 50 for each of the lids 52. The evaluation was performed by visually inspecting the amount and range of stray light that reaches a screen disposed on the +Z side (refer to FIG. 1 and the like) of the optical deflection apparatus 50. As a result, it was found that stray light can be effectively reduced when the light scattering surface 100a has an arithmetic average roughness Ra in the range of 0.5 μm to 4.5 μm. Further, it was found that stray light can be further effectively reduced when the light scattering surface 100a has an arithmetic average roughness Ra in the range of 1.5 μm to 3.5 μm.

As used herein, the arithmetic average roughness Ra refers to the average of the absolute values of heights h(j) in a reference length u. In FIG. 12, the arithmetic average roughness Ra is the average of the absolute values of heights h(j) indicated by dot hatching. Note that the arithmetic average roughness Ra in the range of 0.5 μm to 4.5 μm corresponds to a roughness in the range 15 to 133 according to the Verein Deutscher Ingenieure (VDI).

Such a light scattering surface 100a as described above can be formed by roughening surfaces corresponding to a front surface 522, a back surface 524, and an inner surface 523 by sandblasting or chemical etching in a mold for forming a lid 52. In order to obtain an arithmetic average roughness Ra in the range of 0.5 μm to 2.3 μm, chemical etching is preferably used. In order to obtain an arithmetic average roughness Ra of 2.0 μm or more, sandblasting is preferably used.

Further, the light attenuation portion 100 may be a colored surface that can absorb light reflected by the lid 52.

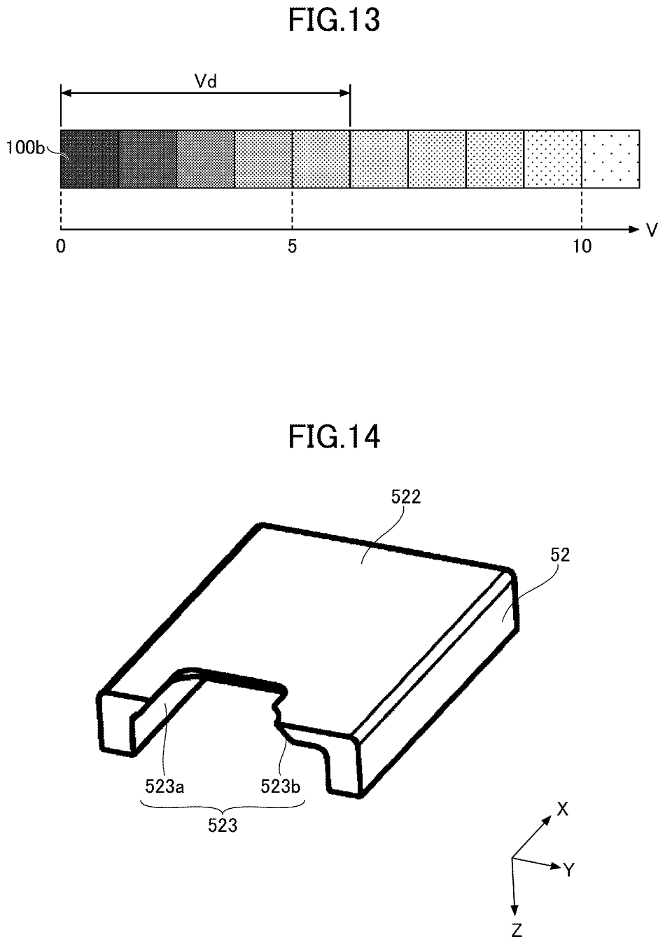

FIG. 13 is a diagram illustrating a colored surface 100b that is a second example of the light attenuation portion 100. FIG. 13 depicts a color bar indicating lightness in the range of 0 to 10.

The inventers made earnest investigations by producing a plurality of lids 52 whose front surfaces 522, back surfaces 524, and inner surfaces 523 have different lightness, and evaluating stray light of an optical deflection apparatus 50 for each of the lids 52. The evaluation was performed in the same manner as that of the above-described surface roughness. As a result, it was found that stray light can be effectively reduced when the colored surface 100b has a lightness Vd in the range of 0 to 5.

As illustrated in FIG. 13, within the lightness Vd in the range of 0 to 5, the colored surface 100b may be a black colored surface having a lightness of approximately 0. Such a colored surface 100b can be formed by painting the surfaces of a lid 52 with a spray or the like, or dyeing the surfaces of a lid 52, formed of a metal material, black.

In the present embodiment, a configuration in which the light attenuation portion 100 is provided on each of the front surface 522, the back surface 524, and the inner surface 523 of the lid 52 has been described; however, the present invention is not limited to this configuration. The light attenuation portion 100 may be provided on a part of at least one of the front surface 522, the back surface 524, and the inner surface 523. If the light attenuation portion 100 is provided on a part, it is preferable to provide the light attenuation portion 100 around the opening 521 through which the laser beam L passes.

Further, as a result of the evaluation of stray light, it was found that light reflected by the front surface 522 of the lid 52 had the largest effect on the stray light, and light reflected by the inner surface 523 had the next largest effect on the stray light. Accordingly, the light attenuation portion 100 is preferably provided on at least the front surface 522, and is more preferably provided on each of the front surface 522 and the inner surface 523.

### Example Configuration of Inner Surface 523 of Opening 521

Referring to FIG. 14 through FIG. 16, the inner surface 523 of the opening 521 will be described.

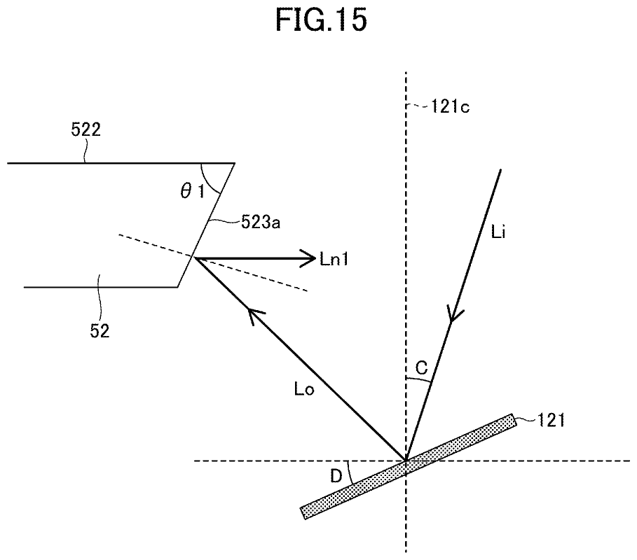

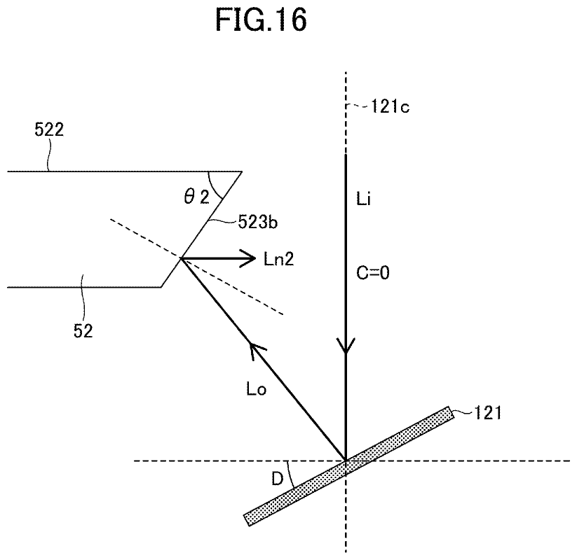

FIG. 14 is a perspective view illustrating a configuration of the inner surface 523 of the opening 521. FIG. 14 depicts the lid 52 cut by a plane perpendicular to the X-axis. FIG. 15 is a cross-sectional view illustrating an example of inclination of a first inner surface 523a of the opening 521. FIG. 16 is a cross-sectional view illustrating an example of inclination of a second inner surface 523b of the opening 521. In FIG. 15 and FIG. 16, the movable member 121 is inclined at a maximum oscillation angle D from a stationary state.

As illustrated in FIG. 14, the inner surface 523 is inclined with respect to the front surface 522 of the lid 52. An appropriate value of the inclination angle varies depending on the position of an inner surface of a plurality of inner surfaces 523 of the opening 521.

As illustrated in FIG. 15, the first inner surface 523a, of the plurality of inner surfaces 523, is a surface located on the opposite side from the side where an incident laser beam Li is incident on the movable member 121, with a stationary central axis 121c being interposed therebetween (see FIG. 15). The stationary central axis 121c is the central axis of the movable member 121 when the movable member 121 is stationary.

The incident laser beam Li travels in a direction that is inclined at an angle C with respect to the stationary central axis 121c, and is incident on the movable member 121. In FIG. 15, Li represents the central axis of the incident laser beam. In FIG. 15, a deflected laser beam Lo is deflected by the movable member 121, and is then reflected by the first inner surface 523a. In FIG. 15, Ln1 represents light reflected by the first inner surface 523a.

In the present embodiment, the following formula (1) is satisfied.

θ1≤C+2·D (1),

where θ1 is an angle between the first inner surface 523a and the front surface 522 of the lid 52.

Further, as illustrated in FIG. 16, the second inner surface 523b, of the plurality of inner surfaces 523 of the opening 521, is a surface other than the first inner surface 523a.

An incident laser beam Li travels in a direction substantially parallel to the stationary central axis 121c, and is incident on the movable member 121. In FIG. 16, a deflected laser beam Lo is deflected by the movable member 121, and is then reflected by the second inner surface 523b. In FIG. 16, Ln2 represents light reflected by the second inner surface 523b.

In the present embodiment, the following formula (2) is satisfied,

θ2≤2·D (2),

where θ2 is an angle between the second inner surface 523b and the front surface 522 of the lid 52.

By satisfying the conditions expressed by the above formulas (1) and (2), the reflected light Ln1, reflected by the first inner surface 523a, and the reflected light Ln2, reflected by the second inner surface 523b, of the deflected laser beam Lo do not travel to the side opposite to the movable member 121 with respect to the front surface 522, and do not exit from the optical deflection apparatus 50. Accordingly, the optical deflection apparatus 50 can prevent stray light due to reflection by the first inner surface 523a and the second inner surface 523b.

### Effects of Optical Deflection Apparatus 50

As described above, the optical deflection apparatus 50 includes the movable member 121 configured to deflect an incident laser beam Li (incident light) from the light emitter, and the lid 52 (lid member) configured to cover the movable member 121. The lid 52 includes the opening 521 through which the incident laser beam Li and a deflected laser beam Lo (deflected light) of the incident laser beam Li pass. The deflected laser beam Lo is deflected by the movable member 121. The lid 52 includes the light attenuation portion 100 configured to attenuate reflected light of the incident laser beam Li or of the deflected laser beam Lo. The reflected light is reflected by the lid 52.

For example, the light attenuation portion 100 is the light scattering surface 100a having an arithmetic average roughness Ra in the range of 0.5 μm to 4.5 μm. Alternatively, the light attenuation portion 100 is the colored surface 100b having a lightness in the range of 0 to 5. The arithmetic average roughness Ra of the light scattering surface 100a is more preferably in the range of 1.5 μm to 3.5 μm.

The light attenuation portion 100 is provided on at least a part of at least one of the front surface 522 (surface on the opposite side of the lid 52 from the movable member), the back surface 524 (surface on the movable member side), and the inner surface 523 of the opening 521 in the lid 52.

By including the light attenuation portion 100, the optical deflection apparatus 50 can attenuate reflected light of the incident laser beam Li or of the deflected laser beam Lo, which is reflected by the lid 52. Accordingly, the optical deflection apparatus 50 capable of reducing stray light can be provided.

### Modifications

The lid according to the embodiment can be modified to have various shapes. In the following, optical deflection apparatuses including lids having various shapes according to modifications will be described.

### First Modification

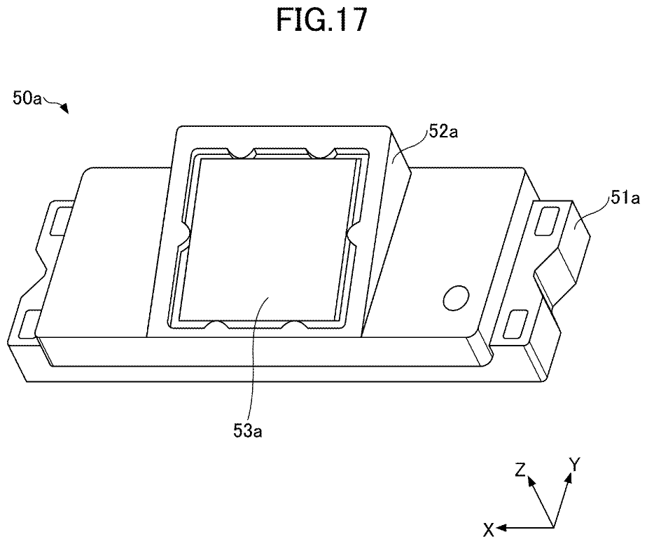

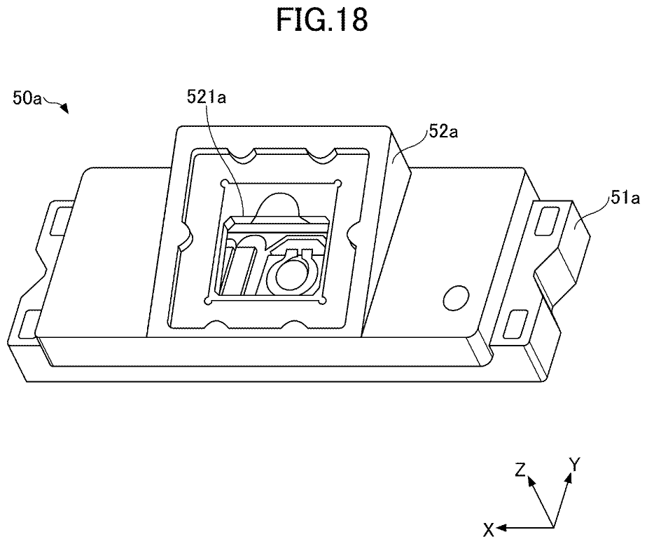

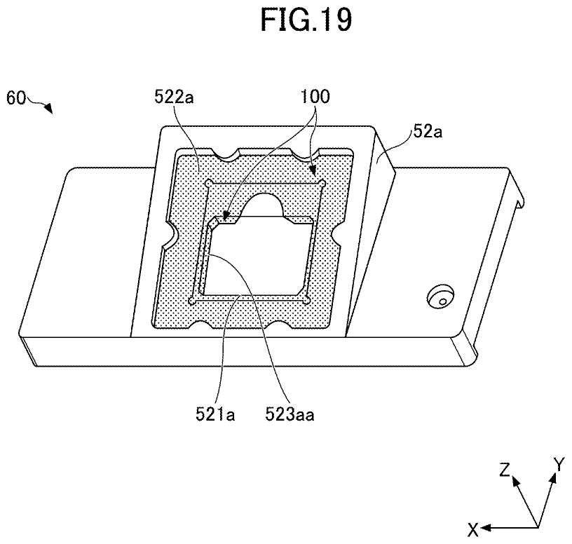

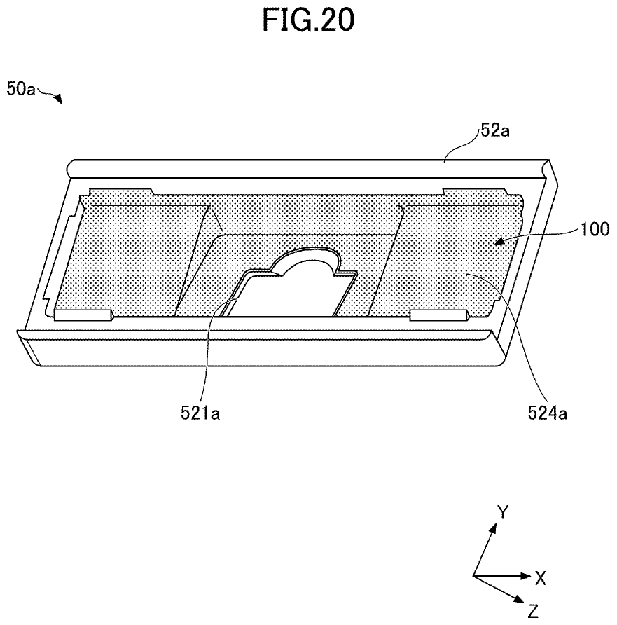

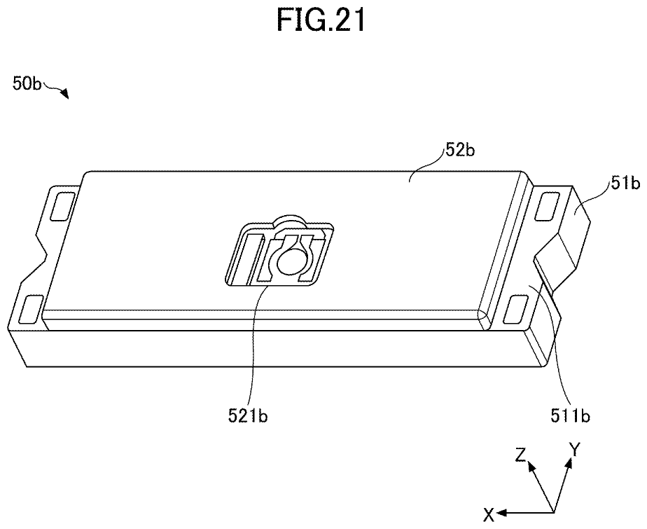

FIG. 17 is a perspective view of an optical deflection apparatus 50a according to a first modification. FIG. 18 is a perspective view of the optical deflection apparatus 50a from which a light transmission plate 53a is removed. FIG. 19 is a diagram illustrating a light attenuation portion 100 provided on each of a front surface 522a of a lid 52a and an inner surface 523aa of an opening 521a of the lid 52a in the optical deflection apparatus 50a. FIG. 20 is a diagram illustrating the light attenuation portion 100 provided on a back surface 524a of the lid 52a.

As illustrated in FIG. 17 through FIG. 20, the optical deflection apparatus 50a includes a package 51a, the lid 52a, and the light transmission plate 53a. The lid 52a is provided on the +Z side of the package 51a in which the optical deflector 1 is included. The lid 52a holds the light transmission plate 53a. In a plan view as viewed in the Z direction, the lid 52a has a substantially rectangular shape that extends in the X direction.

In the optical deflection apparatus 50a as well, the light attenuation portion 100 can be provided on at least a part of at least one of the front surface 522a of the lid 52a, the back surface 524a of the lid 52a, and the inner surface 523aa of the opening 521a of the lid 52a. With the light attenuation portion 100, the optical deflection apparatus 50a can attenuate reflected light of the incident laser beam Li or of the deflected laser beam Lo, which is reflected by the lid 52a. Accordingly, the optical deflection apparatus 50a capable of reducing stray light can be provided.

### Second Modification

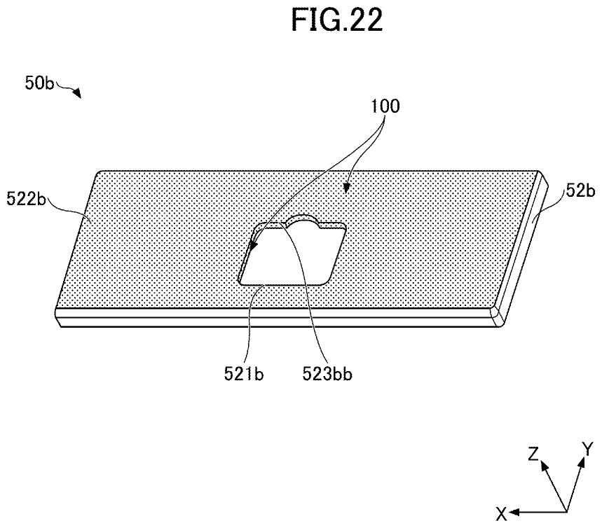

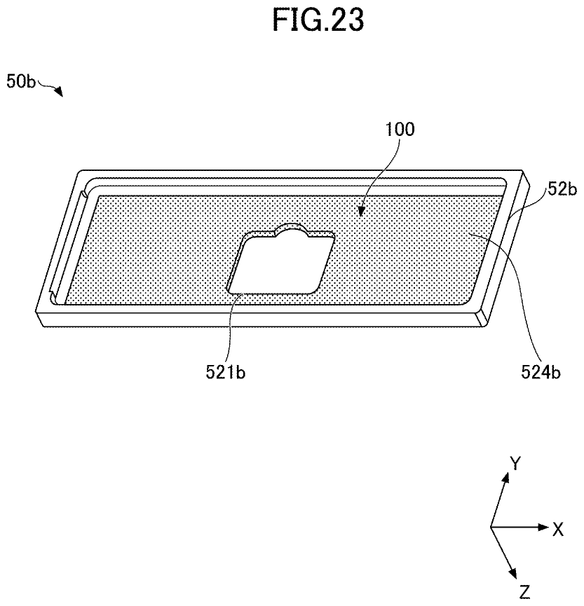

FIG. 21 is a perspective view illustrating a configuration of an optical deflection apparatus 50b according to a second modification. FIG. 22 is a diagram illustrating a light attenuation portion 100 provided on each of a front surface 522b of a lid 52b and an inner surface 523bb of an opening 521b of the lid 52b in the optical deflection apparatus 50b. FIG. 23 is a diagram illustrating the light attenuation portion 100 provided on a back surface 524b of the lid 52b.

As illustrated in FIG. 21 through FIG. 23, the optical deflection apparatus 50b includes a package 51b and the lid 52b. The lid 52b is provided on the +Z side of the package 51b in which the optical deflector 1 is included. The lid 52b does not include a light transmission plate. Further, the lid 52b does not include an inclined portion that holds a light transmission plate in an inclined manner. In a plan view as viewed in the Z direction, the lid 52b has a substantially rectangular shape that extends in the X direction.

In the optical deflection apparatus 50b as well, the light attenuation portion 100 can be provided on at least a part of at least one of the front surface 522b of the lid 52b, the back surface 524b of the lid 52b, and the inner surface 523bb of the opening 521b of the lid 52b. With the light attenuation portion 100, the optical deflection apparatus 50b can attenuate reflected light of the incident laser beam Li or of the deflected laser beam Lo, which is reflected by the lid 52b. Accordingly, the optical deflection apparatus 50b capable of reducing stray light can be provided.

According to the present disclosure, an optical deflection apparatus capable of reducing stray light can be provided.

Although the embodiments have been described above, the present invention is not limited to the embodiments specifically described above, and modifications and variations may be made without departing from the scope of the present invention.

The lid having a substantially square shape or a substantially rectangular shape in a plan view as viewed in the Z direction has been described. However, the lid is not limited to having such a shape, and may have any shape such as a substantially circular shape, an elliptical shape, or a polygonal shape.

The numbers such as ordinal numbers and quantities used in the description of the embodiments are all exemplary for the purpose of describing specifically the techniques of the present invention, and the present invention is not limited to these exemplary numbers.

For example, the optical deflection apparatus according to the embodiments can be used to scan a scan-target surface by deflecting light with an image projection apparatus and the like that projects an image onto the scan-target surface. The image projection apparatus may be, for example, a projector, a welcome projector of a vehicle, a head-up display, a head-mounted display, a headlamp of a vehicle, an object recognition apparatus, a distance measurement apparatus, an ocular fundus camera, or the like.

The welcome projector of the vehicle is a projector provided on a door or the like of the vehicle to project a desired image including a logo when the door is opened. The object recognition apparatus is an apparatus that detects and recognizes the presence or absence of an object or the distance to an object based on reflected light or scattered light, which is reflected or scattered by the object, of projected light.

What is claimed is:

1. An optical deflection apparatus comprising:
a movable member configured to deflect incident light from a light emitter; and
a lid member configured to cover the movable member,
wherein the lid member includes
an opening through which the incident light and deflected light of the incident light pass, the deflected light being deflected by the movable member, and
a light attenuation portion configured to attenuate reflected light of the incident light or of the deflected light, the reflected light being reflected by the lid member.

2. The optical deflection apparatus according to claim 1, wherein the light attenuation portion is a light scattering surface having an arithmetic average roughness Ra in a range of 0.5 μm to 4.5 μm.

3. The optical deflection apparatus according to claim 1, wherein the light attenuation portion is a light scattering surface having an arithmetic average roughness Ra in a range of 1.5 μm to 3.5 μm.

4. The optical deflection apparatus according to claim 1, wherein the light attenuation portion is a colored surface having a lightness in a range of 0 to 5.

5. The optical deflection apparatus according to claim 1, wherein the light attenuation portion is provided on at least a part of at least one of a surface on a moveable member side of the lid member, a surface on an opposite side of the lid member from the moveable member, and an inner surface of the opening of the lid member.

6. The optical deflection apparatus according to claim 1, wherein the opening has a plurality of inner surfaces, and the plurality of inner surfaces include a first inner surface and a second inner surface,
the first inner surface is a surface located on an opposite side from a side where the incident light is incident on the movable member, with a stationary central axis being interposed therebetween, the stationary central axis being a central axis of the movable member when the movable member is stationary, and
the second inner surface is a surface other than the first inner surface, and
formulas (1) and (2) below are satisfied,
θ1≤C+2·D (1)
θ2≤2·D (2)
where θ1 is an angle between the first inner surface and a surface on an opposite side of the lid member from the movable member, and θ2 is an angle between the second inner surface and the surface on the opposite side of the lid member from the movable member, and
where C is an angle between the stationary central axis and a central axis of the incident light, and D is a maximum oscillation angle of the movable member.
